(19) United States
(12) Patent Application Publication
(10) Pub. No.: US 2004/0165215 A1
(43) Pub. Date: Aug. 26, 2004

(54) Image management method and device

(75) Inventors: Emmanuel Raguet, Le Rheu (FR); Pascal Viger, Coesmes (FR)

Correspondence Address: FITZPATRICK CELLA HARPER & SCINTO, 30 ROCKEFELLER PLAZA, NEW YORK, NY, 10112, US

(73) Assignee: Canon Europa N.V., EG Amstelveen (NL)

(21) Appl. No.: 10/758,200

(22) Filed: Jan. 16, 2004

(30) Foreign Application Priority Data
Jan. 16, 2003 (FR) 0300450

(51) Int. Cl. G06F 15/00; H04N 1/00

(52) U.S. Cl. 358/1.15; 358/401; 358/402

(57) ABSTRACT

The present invention proposes an image management method and device. The device can be connected to at least one memory space containing images and selection information selecting images in a first category. Non-selected images are images in a second category. The management method comprises a prior step of configuring at least one image management file containing information relating to the management of the images in the first category and in the second category and being stored in a memory space belonging to the image managing device;

and then, following the connection of a memory space, the management method comprises the following steps of:

obtaining selection information for the images in the memory space;

managing the images in the first category according to the information in the at least one configured image management file; and

managing the images in the second category using the information in the at least one configured image management file.

### FIELD OF THE INVENTION

The present invention concerns a method and device for managing images.

More particularly, the invention relates to a method of managing images coming from an image processing apparatus of the camera type.

Correspondingly, the present invention concerns an image management device able to implement such a method.

### BACKGROUND OF THE INVENTION

The behavior of users of digital cameras is different from the behavior of the user of an analog camera. This is because, with digital images, the user is no longer content with obtaining the image but wishes to carry out various processing steps on it or quite simply to print it or transfer it, thus profiting from its digital format. Each user has his own processing or transfer criteria.

At the present time, in order to carry out image processing, to send images by electronic mail or to a remote server in the Internet or to store or print the photographs coming from the digital camera, the user uses a computer and adapted software for carrying out this processing, messaging for sending images and an Internet site to send the images to a remote server.

Whenever the user wishes to perform these operations, he must boot up the computer and execute one or more software packages according to the operations which he wishes to perform on the images. This is tedious and expensive in terms of time.

There also exist cameras which make it possible to store a configuration file containing for example the address of a remote server. This is explained in particular in the US patent application published under the number 20010022618. The file is configured on the memory card of the camera or on its internal memory. This has the drawback of occupying memory space (internal or on an external card) for the camera. This memory space is however precious for the user who wishes to store a maximum number of photographs.

A standard called DPOF (for: “Digital print order format”) and used on some cameras and some printers makes it possible to select, on the camera, a certain number of photographs for them to be processed by the printer. Version 1.10 of this standard also gives the possibility of specifying an e-mail address or a fax number with the image selected. However, this address or telephone number must be specified when the photographs are selected and therefore each time the user wishes to transfer photographs. This is particularly tedious when the user normally carries out the same operations on his photographs. The functions thus defined by the DPOF standard are limited and often insufficient. It is not possible to increase them indefinitely. This does not make it possible to have an open-ended system. In addition, the DPOF standard makes it possible to perform a particular processing on the images selected but no processing can be specified on the images which have not been selected.

The invention aims to remedy the drawbacks of the state of the art by providing a method of processing images or sequences of images selected on a digital image processing apparatus such as a camera so as to be able to perform various processing steps on these images or sequences of images automatically and changeably and without overloading the memory of the camera or the memory card for the latter. For reasons of simplification, it will be necessary hereinafter to understand the term images as designating images or sequences of images.

### SUMMARY OF THE INVENTION

To this end, the present invention proposes a method of managing images on a device comprising at least one means for connection to at least one memory space containing images and selection information selecting images in a first category. The non-selected images are images in a second category. The method comprises a prior step of:

configuring at least one image management file containing information relating to the management of the images in the first category and to the management of the images in the second category, the image management file being saved in a memory space belonging to the image managing device and different from the memory space containing images and selection information;

then, following the connection of a memory space containing images and selection information, the following steps of:

obtaining selection information for the images in the connected memory space;

managing the images in the first category according to the information in the said at least one configured image management file; and

managing the images in the second category using the information in the said at least one configured image management file.

Thus the management file is configured according to the preferences of the user, the selected images contained in the connected memory space automatically undergo a predetermined management and the images not selected can also automatically undergo a different management.

According to a particular embodiment, the memory space is included or insertable in an image processing apparatus. Connection to the memory space can then also take place by means of the image processing apparatus.

The invention is in fact particularly adapted for a memory space of the memory card type which can be inserted in a camera or an apparatus of the scanner type for example. The user can then choose to connect either the memory card or the image processing apparatus to the management device.

The image processing apparatus may be able to perform an image selection and to supply image selection information.

The image processing apparatus in fact generally has such a possibility, which enables the user to select images easily.

According to a particular feature, the step of configuring at least one image management file is performed on a device comprising a user interface, distant from the device connected to the memory space.

Thus it is possible for the image management device not to have a user interface, which appreciably reduces its cost.

According to a possible feature, the image management device comprises a step of recognizing the apparatus connected or the memory space connected before the execution of the step of obtaining the selection information.

At least one management file corresponds to each processing apparatus or memory card apparatus able to be connected to said device.

Thus it is possible to associate different management files according to the apparatus connected to the management device. Each apparatus can belong to various members of the same family who may wish a different management of these photographs.

The image management steps may comprise one or more steps of applying a processing function to the images.

These processing functions are in no way limited, and may change with the technology and according to the equipment that the user may obtain. This is therefore differentiated from the DPOF standard, in particular, which can apply only limited functions to the selected images.

These processing functions can therefore for example be image transcoding functions, image processing functions of the anti red-eye type, image processing functions, functions of transfer of images via messaging or a network, printing functions, functions of erasure of the image on the memory space or a combination of these functions.

Each processing function can also be associated with a set of parameters useful for applying the function.

This makes it possible to add information to the function to be performed, such as for example the compression ratio for a compression function or a correspondent address for sending by electronic mail.

Correspondingly, the invention relates to an image management device comprising at least one means for connection to at least one memory space containing images and selection information selecting images in a first category. The non-selected images are images in a second category. The device comprises:

at least one memory space belonging to the image managing device, different from the memory space containing images and selection information, and including at least one configurable image management file containing information on the management of the images in the first category and on the management of the images in the second category;

means for obtaining selection information for the images in the connected memory space;

means for managing the images in the first category according to the information in said at least one configured image management file;

means for managing the images in the second category according to the information in said at least one configured image management file.

The image management device comprises means of implementing the above characteristics and has advantages similar to those presented previously.

In one possible embodiment, the image management device is integrated in a printer.

The present invention also relates to a printer comprising at least one means for connection to at least one memory space containing images and selection information selecting images in a first category. The non-selected images are images in a second category. The printer comprises:

at least one memory space belonging to the printer, different from the memory space containing images and selection information, and including at least one configurable image management file containing information on the management of the images in the first category and on the management of the images in the second category;

means for obtaining selection information for the images in the connected memory space;

means for managing the images in the first category according to the information in said at least one configured image management file; and

means for managing the images in the second category using the information in said at least one configured image management file.

This printer has the same advantages as the device mentioned above.

An information medium, possibly totally or partially removable, which can be read by a computer system, contains instructions of a computer program enabling an image management method according to the invention to be implemented.

A computer program stored on an information medium comprises instructions for implementing the image management method according to the invention, when it is loaded into and executed by a computer system.

Other particularities and advantages of the invention will also emerge from the description given below with regard to the accompanying drawings.

### BRIEF DESCRIPTION OF THE DRAWINGS

FIG. 1 depicts a system comprising the management device according to the invention;

FIG. 2 depicts the configuration of the management device according to the invention;

FIG. 3 depicts, in the form of a flow diagram, the principal substeps of the configuration step of the management method of the invention;

FIGS. 4a, 4b, 4c and 4d depict the various look-up tables issuing from the configuration step;

FIG. 5 depicts, in the form of a flow diagram, the principal steps of the image management method according to the invention; and

FIG. 6 depicts in block diagram form a printer adapted to implement the invention.

Naturally many modifications can be made to the embodiments of the invention described above without departing from the scope of the invention.

### DETAILED DESCRIPTION OF THE PREFERED EMBODIMENT

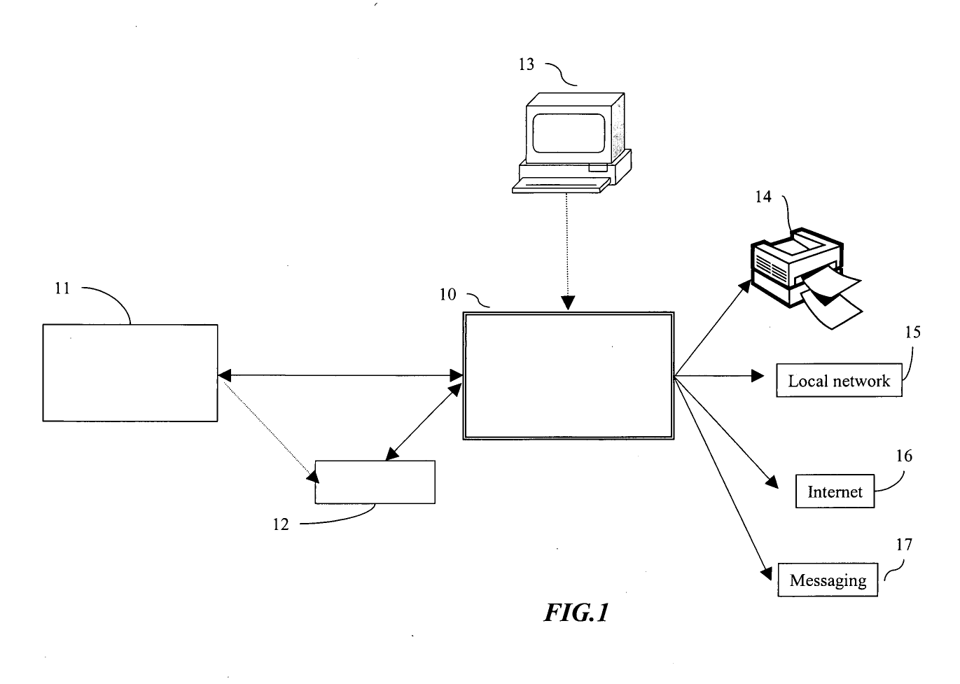

FIG. 1 depicts a system which comprises, amongst other things, the management device 10 according to the invention. This system depicts a network in which various peripherals are connected. The image management device according to the invention comprises various means of connection to external peripherals, in particular image processing peripherals 11 such as for example a camera, a scanner, a video camera or a PDA (for: “Personal Digital Assistant”), peripherals comprising a user interface 13 of the keyboard and screen type such as for example a computer which itself can have access to a local network or a network of the Internet type by means of its own network or by means of the network of the management device 10.

The peripheral 11 can also be a peripheral serving as a relay between an image processing device and the management device 10. This may for example be a portable telephone capable of communicating with the management device 10 by a wireless link (of the 802.11 type for example), this telephone having received images from a remote processing device. The management device can also comprise means of connection to memory media 12 such as memory cards of the compact™ or Microdrive™ type.

The management device can have a network card for connecting to a cabled network (of the Ethernet type) or to a wireless network (of the 802.11 radio type for example) in order to be able to access messaging 17, the Internet 16 or a local network 15. It may thus have access to various Internet sites or send messages.

Finally, the device can connect to other types of peripherals such as for example a printer 14 by means of a network or by a connection of the USB (for: “Universal Serial Bus”) type for example. This device can also be integrated in the printer.

Another possible peripheral can also be a television. The management device 10 will then comprise a video output.

In a preferred embodiment, the image processing apparatus 11 is a photographic apparatus which is connected to the management device by a USB connection. This apparatus can also be connected to the management device by a serial link, a 1394 link (according to IEEE1394) or a wireless link (of the 802.11 type for example). Communication between the image processing apparatus and the management device is then direct.

It is also possible to envisage, in a particular embodiment, a connection between the camera and the management device by means of a network, the management device then comprising a network card and the network or management protocols necessary for communication (for example of the IP “Internet Protocol” or UpnP “Universal Plug and Play” type). Communication between the management device and the image processing apparatus then takes place via the conventional network protocols. The management device will then regularly verify the presence of an image processing apparatus at a predetermined address before implementing the image management method according to the invention.

In the preferred embodiment of the invention, the peripheral comprising a user interface 13 is a microcomputer, and the memory card 12 is a flash card which contains images coming from the photographic apparatus 11.

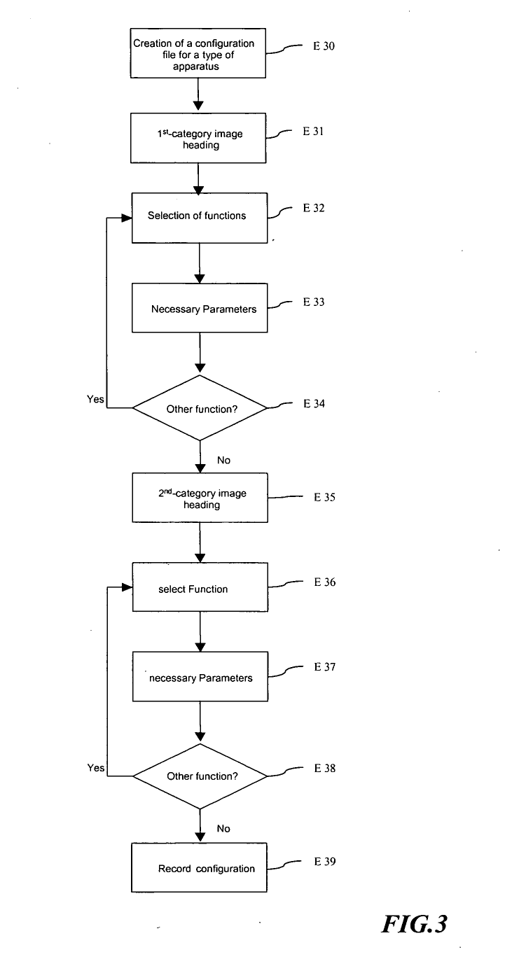

A user wishing to implement the image management method according to the invention will proceed as follows. First of all, the user will create and configure on the user interface 13, in communication with the management device 10, management files for automatically performing given functions on the one hand on the images selected on his camera and on the other hand on the non-selected images. The steps of creating and configuring these files will be described below in relation to FIG. 3.

Using his camera having a selection function of the DPOF (for: “Direct Print Order Format”) type, the user will select the images according to the DPOF standard. This standard offers the possibility for the user to associate, with the images available on the memory spaces connected to the cover, selection information also called a “tag”. This selection information will then serve as a connection to an apparatus which also uses the DPOF standard, to perform on the images of this selection very specific functions provided for by the standard relating to the apparatus in question. In the context of the present invention, selection will not serve, as with the DPOF standard, to perform functions defined by this standard on specific apparatus. The selection thus made will make it possible according to the invention to obtain a selection of images in a first category. The remaining images, available on the memory card of the photographic apparatus, will then be considered to be second-category images. Configured and non-limited functions will then be able to be performed on the two image categories.

The user will then connect to the management device the memory space containing the images and the information on selection of these images either directly or by means of an image processing apparatus.

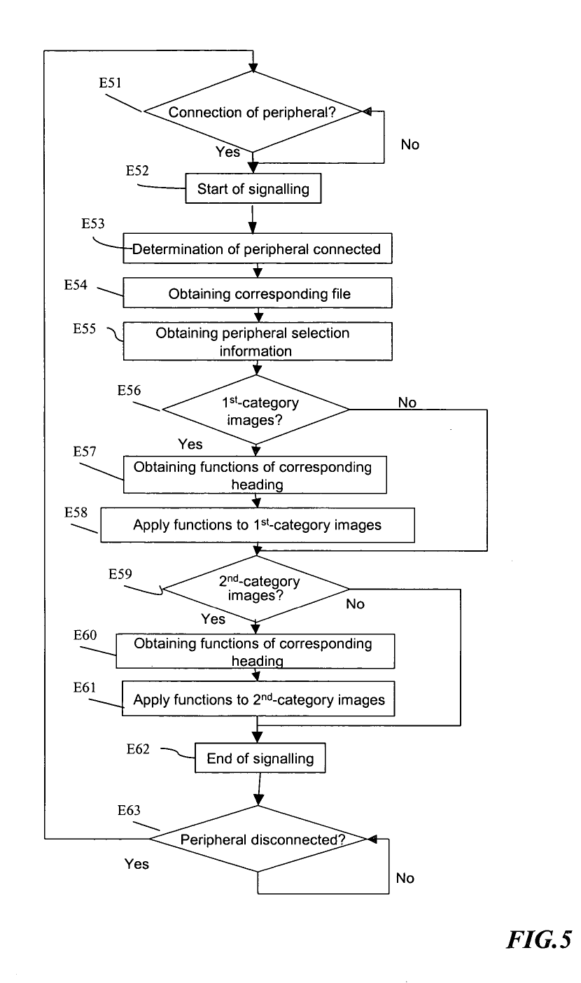

Thus, when the user connects the camera to the management device according to the invention, directly via for example a USB port or indirectly by means of a network or when the user inserts his memory card in the card reader of the management device, the management method will be implemented and the various management steps specified in the management files will be applied to the first-category images and to the second-category images. The method will be described below with reference to FIG. 5.

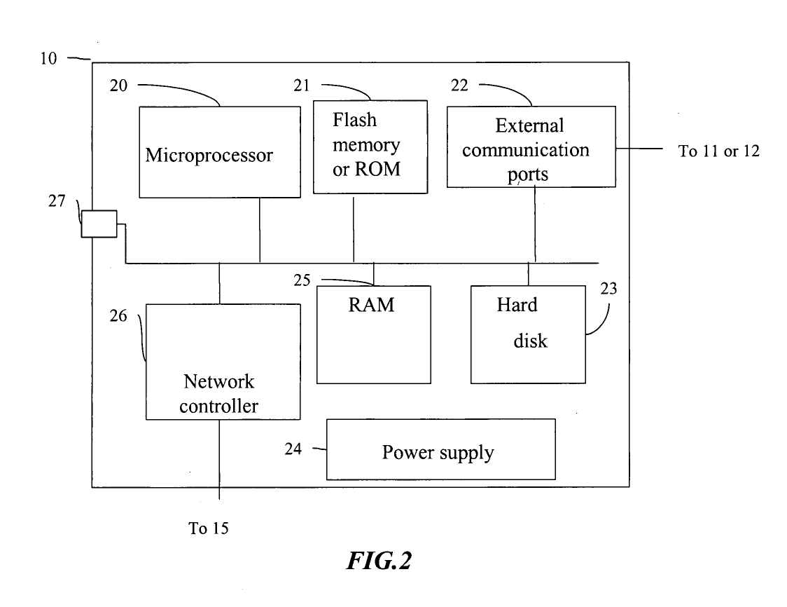

FIG. 2 depicts the image management device 10 according to the invention. This comprises a microprocessor 20 responsible for executing in particular the management file configuration algorithm described in FIG. 3 and the image management algorithm according to the invention described in FIG. 5. The device 10 also comprises a volatile memory RAM 25 (for: “Random Access Memory”) which contains the instructions and registers for implementing the image management method according to the invention.

The device comprises a memory 21 accessible in read mode, such as a Flash memory or ROM (for: “Read Only Memory”) containing the operating program of the microprocessor and the program responsible for starting up the device. The device also comprises a network controller 26 allowing connection to a local cabled network (Ethernet card) or wireless local network (of the 802.11 type). The connection to the network will enable the device to access a device comprising a user interface (of the screen, keyboard or mouse type for example) in order to establish in particular a configuration step as described below.

The device comprises a hard disk 23 on which the data to be kept will be stored, in particular the management files issuing from the configuration step described in FIG. 3, and the photographs downloaded from the camera 11.

Finally, the device comprises a power supply 24 providing the functioning of all the elements of the device, external communication ports 22 affording connections to various peripherals such as an image processing apparatus 11 (a camera in the preferred embodiment), a memory card reader of the flash card type for example.

The management device can also comprise signaling means 27, for example a flashing LED that will signal to the user that the management process is being implemented. When this LED is off, the user will be informed that he can remove the apparatus connected or the memory card.

FIG. 3 depicts the algorithm of the step of configuring the image management files according to the invention.

By means of the device 13 connected to the local network and comprising a user interface, the user will proceed with the management file configuration step. In the preferred embodiment, this device 13 comprising a user interface is a computer in the local network which has access to a Web server coming from a network of the Internet type. This Web server will enable the user to associate functions and the parameters of these functions with at least two categories of image. In a variant, the Web server can be situated in the device 10 and be accessible from the user interface 13.

Thus the operating system of the management device uses a communication protocol of the IP type (where IP stands for “Internet Protocol”) to enable the user to access a configuration page of the web page type, for example via the user interface situated on the device 13. The management file configuration step is then implemented and executed in the RAM memory 25.

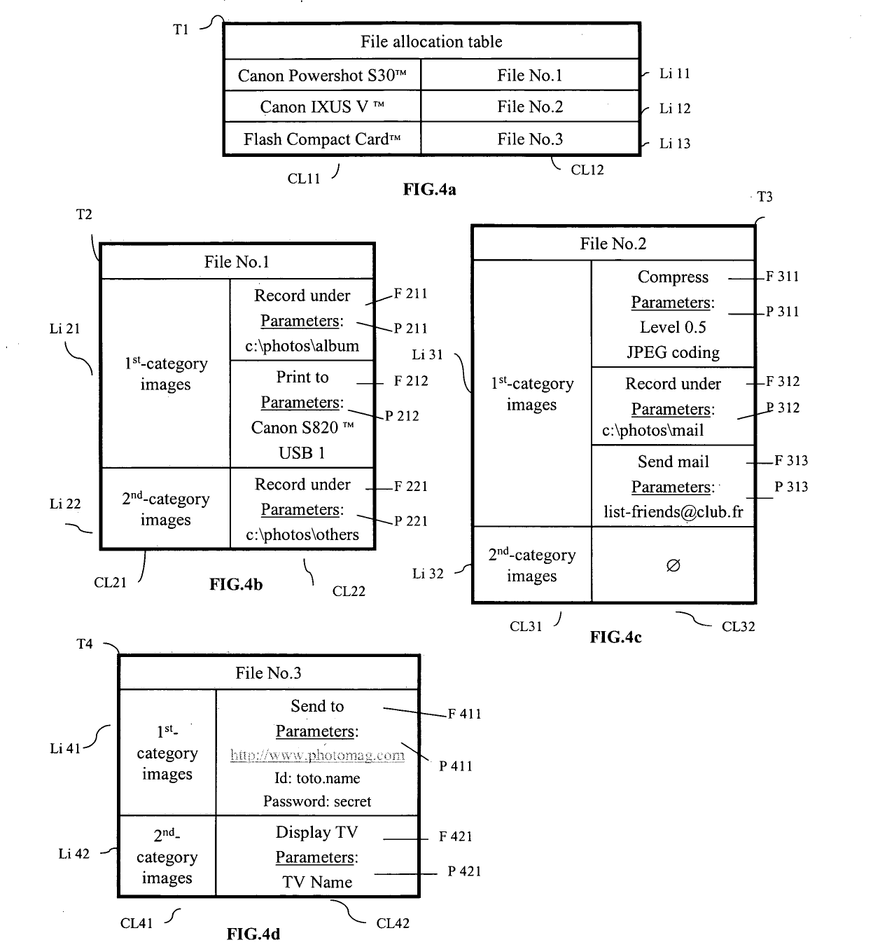

At step E30, a first configuration file is created under the name “file No. 1”. It will correspond to a first image processing apparatus, for example the apparatus “Canon Powershot S30”™. A look-up table between the files and the various items of apparatus will also be initiated. It will be described in relation to FIG. 4a. In a variant, one and the same apparatus can also have several configuration files with different names.

At step E31, the “1^{st}-category image” heading is initiated. The “1^{st}-category image” heading is recorded in a register with the same name in the volatile memory RAM 25. The first-category images are those which the user selected on his image processing apparatus such as the camera. These images will be differentiated from the others by selection information or a “tag”, which will be associated with them as provided for for example by the DPOF standard.

Step E31 is followed by a loop consisting of steps E32 to E34. Step E32 is a step of selecting functions to be performed on these first-category images. The functions may be various. They will in general be image processing functions such as for example a transcoding of an image according to the JPEG standard (where JPEG stands for “Joint Photographic Expert Group”) to an image according to the JPEG 2000 standard, an anti red-eye processing, an image compression with an associated compression ratio, a printing, sending by electronic mail, sending to an Internet site, storing in directories to be defined, deletion of the images in the memory space of the apparatus connected or in the memory card connected or the combining of several functions. These functions are not limited and may be updated over time according to changes in technology or if other items of processing apparatus have been acquired by the user.

This function selection can be made either through a choice of the user amongst a list of functions already provided on the configuration page, or by the creation of a function by the user himself.

Step E33 will make it possible to associate, with the function chosen or created previously, the corresponding parameters. In the case of the “print” function, it may be a case of the required printer, the required resolution or the required print format.

At step E34, an interrogation is carried out in order to determine whether there are other functions to be applied to the first-category images. If so, step E32 is reiterated, or if not step E34 is followed by step E35 or a “2^{nd}-category image” heading is initiated and recorded in a register with the same name in the RAM memory 25.

These second-category images are the other images present on the image processing apparatus or the memory card and which have not been selected by the user. Thus these images can have a different management that the user will define at steps E36 to E38. These steps E36 to E38 are identical to steps E32 to E34 and apply to the second-category images. Functions identical to or different from the functions defined for the first-category images can be configured for the second-category images.

The functions thus defined will then be recorded under the secondcategory image heading. When all the functions have been selected, step E39 records all the data in the corresponding file which in the present case is file No. 1. Examples of representation of this file in look-up table form will be described in relation to FIGS. 4b, 4c and 4d.

The same steps of the algorithm described above will be performed for other configuration files corresponding to other processing apparatus or to memory cards normally used by the user or the members of his family. Thus there may for example be a No. 2 file for the processing apparatus “IXUS V”™ and a file No. 3 for a memory card.

FIG. 4a shows a file allocation table T1 showing the relationships between the various files and the types of processing apparatus or memory card which will be connected to the image management device of the invention. Column CL11 gives the various types of processing apparatus or memory card which will be able to be connected to the image management device.

Column CL12 is the name of the corresponding files which will be recorded in the hard disk 23 of the management device according to the invention. Thus line Li11 shows that, when the user connects the processing apparatus “Canon Powershot S30”™, the management file to be taken into account will be file No. 1. The line Li12 shows that, for the “IXUS V”™ processing apparatus, the management file to be taken into account will be file No. 2. On line Li13, it can be seen that, when the user inserts the memory card of his camera in the card reader available on the management device, the file to be taken into account will be file No. 3.

In a variant, it is possible for the user to have the choice between several files for the same apparatus or card connected. Thus the user will be able to select a file by means for example of the device comprising the user interface, by means of specific buttons on the management device or by means of the user interface provided on the camera connected.

In another variant, it is possible to associate one or more files with an identifier corresponding to this apparatus. This identifier could for example be the serial number of the apparatus connected. Thus a unique identifier corresponds to each apparatus. This will make it possible in particular for members of a family or a group of individuals to access different configured management files even for apparatus of the same model.

FIG. 4b shows a table T2 representing file No. 1. It can therefore be noted that this table comprises 2 headings. A first heading “1^{st}-category images” and a second heading “2^{nd}-category images” listed in column CL21. Column CL22 enumerates the functions and their parameters associated with these image types.

Thus, according to Li21, the functions to be performed for the first-category images are first of all a function F211 “Record under”, for storage of images in a directory given by the associated parameter P211 (c:\photos\album).

A function F212 “print to” is then performed on the Canon S820™ printer available at the output port USB1 of the management device, as indicated by the associated parameters P212.

According to Li22, only one function is to be performed for the second-category images, and this is the function F221 “Record under” whose parameters P221 indicate the directory (c:\photos\autres) in which this storage is to take place.

Naturally various functions can be applied to the two image categories, and in particular the same function can be applied to both categories. This is because the last function for each category could for example be an erasure function. The images will then all be erased from the memory space of the apparatus after having undergone the previous functions of their category.

In the same way, FIGS. 4c and 4d show respectively Tables T3 and T4 representing files No. 3 corresponding to the processing apparatus “IXUS V”™ and No. 4 corresponding to a memory card of the compact flash™ type. It can be seen here that, according to Li31, the functions to be performed for the first-category images are, in the following order, a data compression function F311 with a compression ratio and coding standard defined by the associated parameters P311, a function F312 of recording in a directory given by the parameter P312 and then a function of sending electronic mail F313 “send mail” with one or more sending addresses given by the parameter P313.

Table T3 shows that no function is to be performed for the second-category images of the corresponding apparatus.

Table T4 shows according to Li41 that a function of sending the first-category images is to be performed when a memory card is inserted in the card reader of the management device. The images must be sent to a site (http://www.photomag.com) according to the parameters P411, and an identifier number is also defined, as well as a password.

According to Li42, a function of display on the television F241 “TV display” is to be performed on the second-category images by means of the video output available for example amongst the external communication ports of the management device according to the invention. The associated parameters P421 are then the name of the television which is generally connected.

If the user has not selected any images by means of his camera, when he inserts his memory card in the management device according to the embodiment described above, he will automatically see the photographs from his memory card displayed on his television. If he has selected some photographs on his camera and he connects his IXUS V™ camera, the images which he has selected will be compressed according to the JPEG standard at a compression ratio between the original image and the obtained image of 0.5. They will then be recorded under the directory c:\photos\mail on the hard disk of the image management device and will then be sent by electronic mail to the addresses of the friends listed under the common address “list-friends@club.fr”.

The images which the user has not selected on his IXUS V™ apparatus will not receive any particular processing when the apparatus is connected to the management device.

If the user wishes to modify his configuration files, he will have to access the configuration page which enabled him to create his various files, by means of a device comprising a user interface and communicating with the management device by means of a network for example.

The data saved on the hard disk of the management device will then be displayed and the user will be able to modify them as he wishes before recording them once again on the hard disk of the management device. All the subsequent connections of processing apparatus corresponding to the recorded files will trigger the automatic execution of the functions recorded last in the management files.

Other variants of management files can be envisaged, the functions possible not being limited. They depend only on the means available on the network comprising the management device. These functions can therefore be open to change.

It is possible for example for a management file to specify functions only on the second-category images, for example a deletion or a compression at very high ratio, and not on the first-category images. The user then selects the images which he prefers, and the others will be deleted or compressed greatly for archiving, the action of selecting the most attractive photographs being the most natural for the user.

FIG. 5 depicts an algorithm depicting the various steps performed during the image management method according to the invention. This method is implemented in the image management device. The algorithm can be stored in whole or in part in any information storage means capable of cooperating with the microprocessor. This storage means is integrated or not into the device, and may be removable. For example it may comprise a magnetic tape, a diskette or a CD-ROM (fixed-memory compact disk).

At step E51, a test is carried out in order to determine whether a peripheral is connected. It may be a case either of an image processing apparatus 11 or a memory card 12. If a peripheral is detected, signaling will be initiated. In a preferred mode, this signaling will be a flashing LED 27 which will warn the user that the management method is being implemented.

As soon as the operating system present in the management device detects that a peripheral is connected, it will determine which peripheral is involved at step E53. First of all, according to the connection established, it will be able to determine whether it is a case of a processing apparatus connected to the USB port in a preferred embodiment or a memory card inserted in the card reader. Next, if it is a case of a processing apparatus, the apparatus identifier will make it possible to determine the name of the apparatus connected. This is because, according to the USB protocol, an apparatus connected to the management device will have at least two identifiers, one corresponding to the manufacturer of the apparatus and one corresponding to the model of the apparatus. Thus, by recovering this information, the management device will be in a position to identify the apparatus connected.

At step E54, the microprocessor will seek on the hard disk the management file corresponding to the apparatus connected or to the memory card inserted and will load it into the RAM memory in order to execute it. Step E54 is followed by step E55, which will seek the selection information contained in the apparatus connected or on the memory card inserted.

This selection information is, as described above, the information on the categories of the images available on the apparatus or the memory card.

In another embodiment, step E55 can also consist of the downloading, into a temporary file, of all the images contained in the memory space of the apparatus connected or of the memory card connected. In this case, the selection information is downloaded at the same time as the images.

At step E56, a test is carried out in order to determine whether first-category images exist, that is to say images which were selected by the user on his camera.

If such is the case, step E56 is followed by step E57 in which the microprocessor will obtain the functions which correspond to the heading of the first-category images. At step E58, these functions will be applied to the first-category images.

In the case of file No. 1 in FIG. 4b, the function to be applied first is a function of recording the images in a given directory. In this case, the first-category images will be downloaded on the management device in the corresponding directory. The function to be applied secondly is a print function. In this case the data corresponding to the first-category images will be transferred by means of the USB port for example, to the printer connected, with the format or resolution information defined in the management file.

Step E58 is followed by step E59. Likewise, if at step E56 no first-category images are found, step E59 is passed to where a test is performed in order to determine whether second-category images exist.

For this purpose, either the management device obtains a list of the names of the images contained in the camera or on the memory card and deduces therefrom, by eliminating the names of the first-category images, whether second-category images exist, or it downloads, into a temporary file, all the images from the apparatus connected or the memory card inserted and deletes the first-category images so as to keep only the second-category images if such remain. If such is the case, step E60 is passed to in which the functions corresponding to the second-category image heading will be obtained.

At step E61, the functions are applied to the second-category images, that is to say the images which the user has not selected on his camera.

In the case of File No. 1 in FIG. 4b, the function to be applied is a function of recording in a given directory. There also, it will be necessary to download the second-category images into the appropriate directory or to transfer the images already downloaded during step E59 or E55 to the appropriate directory on the hard disk.

Some functions may not require downloading, such as for example the function of deletion on the apparatus or memory card.

If at step E59 the test is negative, that is to say there are no images other than the first-category images on the medium connected, then step E62 is passed to where the signaling stops in order to advise the user that he can disconnect his apparatus or remove his memory card since the management process is ended. A test is then performed at step E63 until the disconnection of the apparatus or memory card is detected. When the apparatus or card is disconnected, the previously described step E51 is returned to.

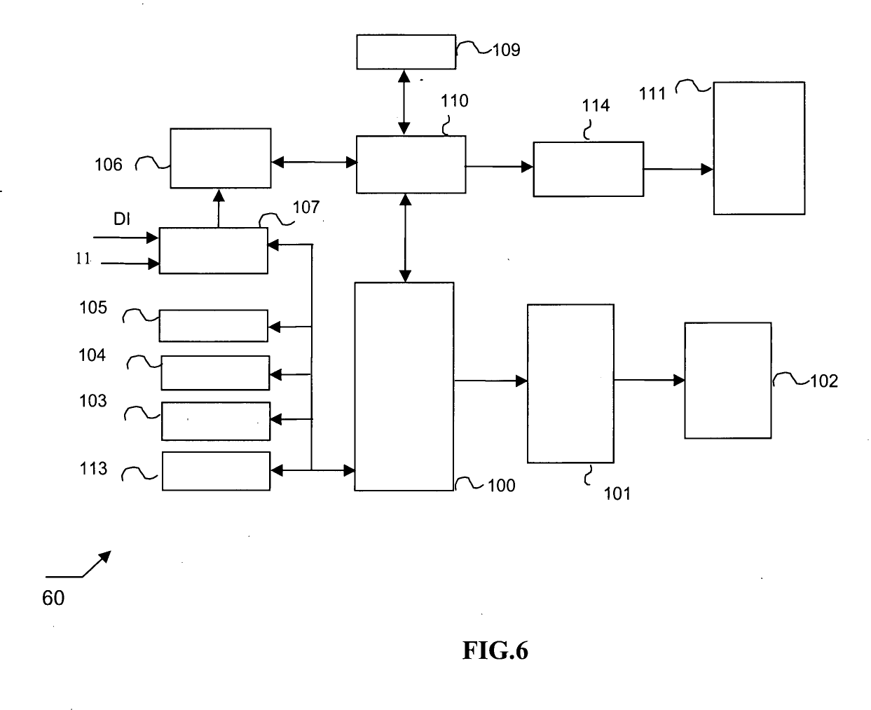

With reference to FIG. 6, another embodiment adapted to implement an image management method according to the present invention will be described. An image transfer device such as a printer will thus be described, adapted to implement a display method according to the present invention and described previously with reference to FIGS. 3 to 5.

It should be noted that the printer illustrated in FIG. 6 constitutes a particular embodiment of the general device 10 described above in relation to FIG. 2.

The following description refers particularly to an inkjet printer. The printer 60 receives data to be printed Dl by means of one of the external communication ports 107 of the USB type for example connected to an interface circuit 106. The circuit 106 is connected to an ink ejection control circuit 110, which controls an ink cartridge 111, via an amplification circuit 114.

The ink cartridge is exchangeable and is mounted on a reciprocating carriage actuated by a motor 102.

The printer also comprises a main data processing circuit 100, associated with a read only memory 103 and a random access memory 109. The read only memory 103 contains the operating programs of the main processing circuit 100, whilst the random access memory 109, also associated with the ink ejection control circuit 110, temporarily stores the data Dl received by means of the interface 106 as well as the data processed by the main processing circuit 100.

The main processing circuit 100 is connected to a display 105 on which the main processing circuit 100 controls the display of the messages representing the functioning of the printer.

The main processing circuit 100 is also connected to the motor 102 by means of an amplification circuit 101. The motor 102 provides the movement of the carriage which carries the print cartridge 111. The motor 102 is for example a stepping motor.

According to the invention, the main processing circuit 100 is responsible in particular for executing the management file configuration algorithm described in FIG. 3 and the image management algorithm according to the invention described in FIG. 5. The random access memory 109 comprises in particular the instructions and registers for implementing the image management method according to the invention.

The printer also comprises a network controller 113 affording a connection to a local cabled network (Ethernet card) or wireless local network (of the 802.11 type for example). The connection to the network will enable the printer to access a device comprising a user interface in order to establish in particular a configuration step as described in FIG. 3. This network controller will also make it possible to perform the image management such as the sending of images to a messaging service, to an Internet site or to a remote storage means for example.

The printer according to the invention also comprises an internal storage means 104, of the non-volatile memory such as a EEPROM in which the data to be kept are stored, in particular the management files issuing from the configuration step described in FIG. 3, the photographs downloaded from the camera connected or from the memory card connected.

The external communication ports 107 make it possible in particular to connect an image processing apparatus 11 (of the camera type for example) or a memory card (of the flash card type for example).

The printer, by means of its display 105, can also advise the user that the management method according to the invention is being implemented. The user will also be informed of the end of the management process so that he can remove the apparatus or card connected.

Naturally the present invention is not limited to the details of the embodiments described here by way of example but on the contrary extends to any modifications within the capability of a person skilled in the art, without departing from the scope of the invention.

1. A method of managing images on a device comprising at least one means for connection to at least one memory space containing images and selection information selecting images in a first category, non-selected images being images in a second category, the method comprising a prior step of:
configuring at least one image management file containing information relating to the management of the images in the first category and to the management of the images in the second category, the image management file being saved in a memory space belonging to the image managing device and different from the memory space containing images and selection information;
then, following the connection of a memory space containing images and selection information, the following steps of:
obtaining selection information for the images in the connected memory space;
managing the images in the first category according to the information in the said at least one configured image management file; and
managing the images in the second category using the information in the said at least one configured image management file.

2. A management method according to claim 1, wherein said memory space is included in or can be inserted in an image processing apparatus.

3. A management method according to claim 1, wherein the connection to a memory space takes place by means of an image processing apparatus.

4. A management method according to claim 3, wherein the image processing apparatus is able to make a selection of images and to supply image selection information.

5. A management method according to claim 1, wherein the step of configuring at least one image management file is performed on a device comprising a user interface, distant from the device connected to the memory space.

6. A management method according to claim 1, comprising a step of recognizing the apparatus connected or the memory space connected before the performance of the step of obtaining the selection information.

7. A management method according to claim 6, comprising a step of selecting at least one configured management file corresponding to the apparatus or to the connected memory space.

8. A management method according to claim 3, wherein at least one management file corresponds to each processing apparatus or memory card able to be connected to said device.

9. A method according to claim 1, wherein the image management steps comprise one or more steps of applying a processing function to the images.

10. A method according to claim 9, wherein, with each processing function, a set of parameters is associated, which is usable for the application of the function.

11. A method according to claim 9, wherein the processing functions are in the list consisting of image compression, anti red-eye processing, transfer via a messaging service, transfer over a communication network, printing, transcoding or a combination of the above functions.

12. An image management device comprising:
at least one means for connection to at least one memory space containing images and selection information selecting images in a first category, non-selected images being images in a second category;
at least one memory space belonging to the image managing device, different from the memory space containing images and selection information, and including at least one configurable image management file containing information on the management of the images in the first category and on the management of the images in the second category;
means for obtaining selection information for the images in the connected memory space;
means for managing the images in the first category according to the information in said at least one configured image management file;
means for managing the images in the second category according to the information in said at least one configured image management file.

13. An image management device according to claim 12, wherein said memory space is included in or can be inserted in an image processing apparatus.

14. An image management device according to claim 12, wherein the connection to a memory space is made by means of an image processing apparatus.

15. An image management device according to claim 14, wherein the image processing apparatus is able to make a selection of images and to supply image selection information.

16. An image management device according to claim 14, comprising means for recognizing an image processing apparatus or a memory space which is connected to it.

17. An image management device according to claim 12, wherein the image management means are means for applying processing functions to the images.

18. An image management device according to claim 12, comprising access to a network of the Internet type.

19. An image management device according to claim 12, comprising an access to a messaging service.

20. An image management device according to claim 12, comprising an access to a printer.

21. An image management device according to claim 12, comprising an access to a storage means.

22. An image management device according to claim 12, comprising image transcoding means.

23. An image management device according to claim 12, characterized in that it is integrated in a printer.

24. A printer comprising:
at least one means for connection to at least one memory space containing images and selection information selecting images in a first category, non-selected images being images in a second category;
at least one memory space belonging to the printer, different from the memory space containing images and selection information, and including at least one configurable image management file containing information on the management of the images in the first category and on the management of the images in the second category;
means for obtaining selection information for the images in the connected memory space;
means for managing the images in the first category according to the information in said at least one configured image management file; and
means for managing the images in the second category using the information in said at least one configured image management file.

25. An information carrier, possibly totally or partially removable, which can be read by a computer system, containing instructions for a computer program for implementing the image management method according to claim 1.

26. A computer program stored on an information carrier, said program comprising instructions for implementing the image management method according to claim 1 when it is loaded in and executed by a computer system.
